(19) United States
(12) Patent Application Publication
(10) Pub. No.: US 2014/0233727 A1
(43) Pub. Date: Aug. 21, 2014

(54) METHOD FOR SECURE SUBSTRING SEARCH

(71) Applicant: RAYTHEON BBN TECHNOLOGIES CORP., Cambridge, MA (US)

(72) Inventors: Kurt Rohloff, Hadley, MA (US); David Bruce Cousins, Barrington, RI (US); Richard Schantz, Sharon, MA (US)

(21) Appl. No.: 14/081,617

(22) Filed: Nov. 15, 2013

Related U.S. Application Data
(60) Provisional application No. 61/727,653, filed on Nov. 16, 2012.
(60) Provisional application No. 61/727,654, filed on Nov. 16, 2012.

(51) Int. Cl. H04L 9/00; G06F 17/30

(52) U.S. Cl. CPC H04L 9/008; G06F 17/3069
USPC 380/28; 707/772

(57) ABSTRACT

A system and method for secure substring search, using fully homomorphic encryption, or somewhat homomorphic encryption. In one embodiment, a first string is homomorphically compared to trial substrings of a second string, each comparison producing a ciphertext containing an encrypted indication of whether the first string matches the trial substrings. These ciphertexts are then combined in a homomorphic logical OR operation to produce a ciphertext which contains an encrypted indication of whether the first string matches any of the trial substrings, i.e., whether the first string is contained in the second string.

### CROSS-REFERENCE TO RELATED APPLICATION(S)

The present application claims priority to and the benefit of Provisional Application No. 61/727,653, filed Nov. 16, 2012, entitled “METHOD FOR SECURE SUBSTRING SEARCH” and Provisional Application No. 61/727,654 filed Nov. 16, 2012, entitled “METHOD FOR SECURE SYMBOL COMPARISON”, the contents of both of which are hereby incorporated herein by reference.

### STATEMENT REGARDING FEDERALLY SPONSORED RESEARCH OR DEVELOPMENT

This invention was made with U.S. Government support under contract No. Contract No. FA8750-11-C-0098 awarded by the Defense Advanced Research Projects Agency (DARPA). The U.S. Government has certain rights in this invention.

### BACKGROUND

1. Field

This invention relates to the field of encryption and, more particularly, to a method useful in securely computing on encrypted data.

In one embodiment, the, present invention relates to a method to securely determine whether an encrypted message, e.g., a first string, is contained within another encrypted message, e.g., a second string, without the use of secret keys.

2. Description of Related Art

Homomorphic encryption is a form of encryption which enables the performing of an operation on a pair of ciphertexts, producing a result which when decrypted is the same as if a corresponding operation had been performed on the plaintexts. The ciphertext operations for performing homomorphic multiplication and addition are referred to herein as EvalMult and EvalAdd, respectively. Throughout this disclosure the EvalAdd and EvalMult operations are understood to be modulus-2 operations, i.e., they are modulus-2 homomorphic addition and modulus-2 homomorphic multiplication, respectively.

For example, denoting the encryption and decryption operation as Enc and Dec respectively, we have for plaintexts aₗ and a₂, Dec(EvalMult(Enc(a₁), Enc(a₂)))=a₁*a₂, i.e., encrypting each of a₁ and a₂, operating on the resulting ciphertexts with the EvalMult operation, and decrypting the result, yields the product of a₁ and a₂, where modulus-2 arithmetic is implied throughout.

Similarly, the EvalAdd operation in a homomorphic encryption scheme has the property that for plaintexts a₁ and a₂, Dec(EvalAdd(Enc(a₁), Enc(a₂)))=a₁+a₂, i.e., encrypting each of a₁ and a₂, operating on the resulting cyphertexts with the EvalAdd operation and decrypting the result yields the sum of a₁ and a₂, where again modulus-2 arithmetic is implied throughout.

A homomorphic encryption scheme is referred to herein as somewhat homomorphic encryption (SHE) if its homomorphic characteristics support only a finite number of sequential EvalAdd or EvalMult operations. The number of EvalMult operations that may successively be performed on ciphertexts while ensuring that the result, when decrypted, will equal the product of the corresponding plaintexts is referred to herein as the multiplicative degree, or the depth, of the encryption scheme. An additive degree may be defined in an analogous manner. A somewhat homomorphic encryption scheme may have infinite additive degree but finite multiplicative degree. A homomorphic encryption scheme which has infinite additive degree and infinite multiplicative degree is referred to herein as a fully homomorphic encryption (FHE) scheme.

An encryption scheme may be referred to as partially homomorphic if it supports only an EvalAdd or an EvalMult operation, but not both.

Homomorphic encryption may be useful, for example if an untrusted party is charged with processing data without having access to the data. A trusted party or data proprietor may encrypt the data, deliver it to the untrusted party, the untrusted party may process the encrypted data and return it to the data proprietor or turn it over to another trusted party. The recipient may then decrypt the results to extract the decrypted, processed data.

The operations desired may include comparison of strings, and, in particular, the determination of whether a first string is a sub string of a second string, also referred to as a substring search. An untrusted party may, for example, receive ciphertexts corresponding to two strings, a first string and a second string, from one or more data proprietors, and may wish to send a third party an encrypted indication of whether the first string is a substring of the second string, which the third party may decrypt, obtaining for example a binary 1 if the first string is a substring of the second string, and a binary 0 otherwise. Thus, there is a need for a method for secure substring search.

### SUMMARY

Aspects of embodiments of the present invention enable fundamental capabilities for secure computing on encrypted data. As such, a user may encrypt data, share the data with an untrusted 3rd party that may compute algorithms on this data without access the original data or encryption keys such that the result of running the algorithm on the encrypted data may be decrypted to a result which is equivalent to the result of running the algorithm on the original unencrypted data. This invention could be used by cloud computing hosts, financial institutions and any other commercial entity that may like to use or offer secure computing.

In one embodiment, the first string is homomorphically compared to trial substrings of the second string, each comparison producing a ciphertext containing an encrypted indication of whether the first string matches the trial substrings. These ciphertexts are then combined in a homomorphic logical OR operation to produce a ciphertext which contains an encrypted indication of whether the first string matches any of the trial substrings, i.e., whether the first string is contained in the second string.

According to an embodiment of the present invention there is provided a method for determining whether a first string is a substring of a second string, the method including: performing a first sequence of operations, on: a set of first ciphertexts corresponding to the first string; and a set of second ciphertexts corresponding to a trial substring of the second string, to form a resulting third ciphertext containing an encrypted indication of whether the first string matches the trial substring.

In one embodiment, the first sequence of operations includes one or more EvalAdd operations and one or more EvalMult operations.

In one embodiment, the method includes: performing the first sequence of operations one or more times for a plurality of trial substrings to form a plurality of resulting third ciphertexts, each time selecting as the trial substring a different substring of the second string, the sub string of the second string having the same length as the first string; and performing a second sequence of operations on the plurality of resulting third ciphertexts; to form a fourth ciphertext.

In one embodiment, each of the plurality of resulting third ciphertexts contains an encrypted indication of whether the first string matches a corresponding trial substring of the second string.

In one embodiment, the fourth ciphertext contains an encrypted indication of whether the first string is a substring of the second string.

In one embodiment, the method includes: converting each symbol into a binary representation of the symbol; encoding each binary representation to form a first set of plaintext vectors; and encrypting each plaintext vector with a homomorphic encryption scheme to form a ciphertext.

In one embodiment, the first sequence of operations includes: performing an EvalAdd operation with: a ciphertext corresponding to a bit of a binary representation of a symbol of the first string; and a ciphertext corresponding to a corresponding bit of a binary representation of a corresponding symbol of the trial substring; to obtain a first intermediate ciphertext; performing an EvalAdd operation with: the first intermediate ciphertext; and a ciphertext encrypting a vector of bits with a leading 1; to obtain a second intermediate result.

In one embodiment, the method includes performing an EvalMult operation on a plurality of second intermediate results to obtain a resulting third ciphertext.

In one embodiment, the method includes: homomorphically inverting each of a plurality of resulting third ciphertexts to obtain a first plurality of inverses; performing an EvalAdd operation with the first plurality of inverses to obtain a first intermediate product; and homomorphically inverting the first intermediate product to form the fourth ciphertext, wherein the homomorphically inverting includes performing an EvalAdd operation with: a quantity being homomorphically inverted; and a ciphertext encrypting a vector of bits with a leading 1.

In one embodiment, the encrypting of each plaintext vector with a homomorphic encryption scheme includes encrypting each plaintext vector with a fully homomorphic encryption scheme.

According to an embodiment of the present invention there is provided a system for determining whether a first string is a substring of a second string, the system including a processing unit configured to perform a first sequence of operations, on: a set of first ciphertexts corresponding to the first string; and a set of second ciphertexts corresponding to a trial substring of the second string, to form a resulting third ciphertext containing an encrypted indication of whether the first string matches the trial substring.

In one embodiment, the first sequence of operations includes one or more EvalAdd operations and one or more EvalMult operations.

In one embodiment, the processing unit is configured to: perform the first sequence of operations one or more times for a plurality of trial substrings to form a plurality of resulting third ciphertexts, each time selecting as the trial sub string a different substring of the second string, the substring of the second string having the same length as the first string; and perform a second sequence of operations on the plurality of resulting third ciphertexts; to form a fourth ciphertext.

In one embodiment, each of the plurality of resulting third ciphertexts contains an encrypted indication of whether the first string matches a corresponding trial substring of the second string.

In one embodiment, the fourth ciphertext contains an encrypted indication of whether the first string is a substring of the second string.

In one embodiment, each of the first string and the trial substring of the second string include symbols, the processing unit further configured to: convert each symbol into a binary representation of the symbol; encode each binary representation to form a first set of plaintext vectors; and encrypt each plaintext vector with a homomorphic encryption scheme to form a ciphertext.

In one embodiment, the first sequence of operations includes: performing an EvalAdd operation with: a ciphertext corresponding to a bit of a binary representation of a symbol of the first string; and a ciphertext corresponding to a corresponding bit of a binary representation of a corresponding symbol of the trial substring; to obtain a first intermediate ciphertext; performing an EvalAdd operation with: the first intermediate ciphertext; and a ciphertext encrypting a vector of bits with a leading 1; to obtain a second intermediate result.

In one embodiment, the processing unit is further configured to perform an EvalMult operation on a plurality of second intermediate results to obtain a resulting third ciphertext.

In one embodiment, the processing unit is further configured to: homomorphically invert each of a plurality of resulting third ciphertexts to obtain a first plurality of inverses; perform an EvalAdd operation with the first plurality of inverses to obtain a first intermediate product; and homomorphically invert the first intermediate product to form the fourth ciphertext, wherein the homomorphically inverting includes performing an EvalAdd operation with: a quantity being homomorphically inverted; and a ciphertext encrypting a vector of bits with a leading 1.

In one embodiment, the encrypting of each plaintext vector with a homomorphic encryption scheme includes encrypting each plaintext vector with a fully homomorphic encryption scheme.

### BRIEF DESCRIPTION OF THE DRAWINGS

Features, aspects, and embodiments are described in conjunction with the attached drawings, in which:

FIG. 1 is a dataflow diagram of a method for secure substring search, according to an embodiment of the present invention;

FIG. 2 is a dataflow diagram of a method for secure string matching, according to an embodiment of the present invention;

FIG. 3 is a flow chart illustrating a method for secure string matching, according to an embodiment of the present invention; and

FIG. 4 is a flow chart illustrating a method for secure substring search, according to an embodiment of the present invention.

### DETAILED DESCRIPTION

The detailed description set forth below in connection with the appended drawings is intended as a description of exemplary embodiments of a method for secure substring search provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

In one embodiment of a method for secure substring search, each of the two strings is encrypted, by mapping each symbol in the string to a binary number, encoding each binary number into a set of binary vectors, and encrypting each binary vector into a ciphertext, using a FHE or SHE encryption scheme. This sequence of steps results in ciphertexts which are suitable for homomorphically determining whether a first string is a substring of a second string.

In one such embodiment, the first string, which is a sequence of d1 symbols, is first mapped, one symbol at a time, to a binary representation, using a mapping such as the American Standard Code for Information Interchange (ASCII), which maps symbols into 7-bit binary numbers. This results in a sequence of k1 bits, where k1 is 7*d1 if ASCII is used to encode each symbol, and where k1 may have a different value if another mapping, generating a different number of bits for some or all of the symbols, is used. Each bit of each symbol is then encoded into a vector of bits, of length m. This encoding consists of using the bit of the symbol as the first bit of the vector, and setting the remaining bits of the vector to 0. Such vectors of bits of length m are referred to herein as m-bit-vectors; an m-bit-vector in which the first bit is a 1 is referred to as an m-bit-vector with leading 1, and an m-bit-vector in which the first bit is a 0 is referred to as an in-bit-vector with leading 0. The m-bit-vectors are encrypted using a homomorphic encryption scheme to form sets of ciphertexts, one set for each of the symbols, and each ciphertext corresponding to one bit of the binary representation of one symbol.

At the conclusion of this process, the first string is represented by a set of ciphertexts which may be written c11, c12, . . . , c1(k1), where each of the c1i is a ciphertext corresponding to one bit of the binary representation of one symbol. For the second string, which is a sequence of d2 symbols, an analogous process is used to map it to a sequence of k2 bits and to form a second set of k2 ciphertexts, which may be written c21, c22, . . . , c2(k2) representing the second string, which is mapped to a sequence of k2 bits.

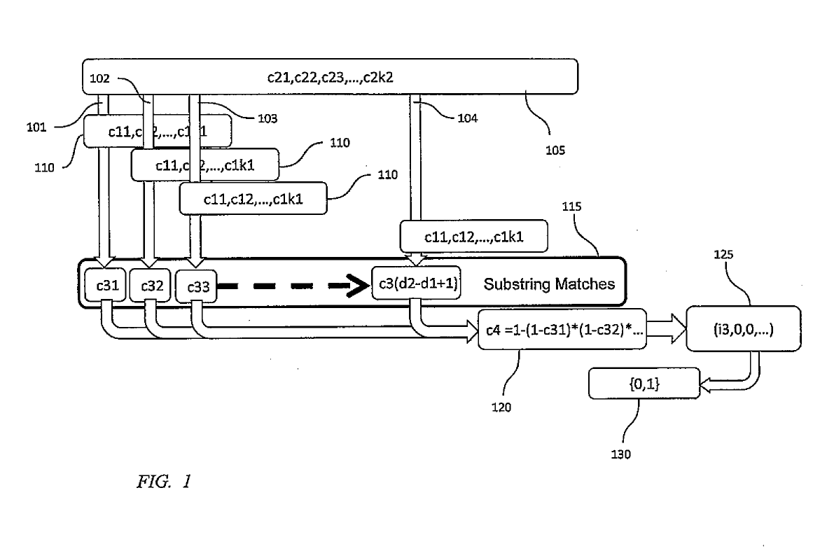

Referring to FIG. 1, the two sets of ciphertexts may then be processed to determine homomorphically whether the first string is a substring of the second string. In one embodiment, this is accomplished by homomorphically comparing the first string to trial substrings of the second string, and by then combining the results of all of the comparisons to form a final ciphertext containing an indication of whether the first string matched any of the trial substrings, i.e., whether the first string is contained in the second string.

In particular, the method proceeds by selecting from the second set of ciphertexts, a trial subset, e.g., c21, c22, . . . , c2(k1), corresponding to a trial substring of the second string, homomorphically comparing the trial subset to the set of ciphertexts corresponding to the first string to produce a ciphertext, e.g., c31, which contains an encrypted indication of whether the first string matches the trial substring, repeating this process for all d2−d1+1 substrings of length d1 contained in the second string, to produce a sequence of ciphertexts c31, c32, . . . , c3(d2−d1+1), and combining the ciphertexts c31, c32, . . . , c3(d2−d1+1) in a sequence of homomorphic operations to generate a ciphertext c4 which contains an encrypted indication of whether the first string is a substring of the second string.

In FIG. 1, trial subsets, e.g., 101, 102, 103, 104, of the set 105 of ciphertexts corresponding to the second string, are each compared homomorphically to ciphertexts 110 corresponding to the first string. To select trial subsets so that each corresponds to a trial substring, the untrusted third party must be able to determine where, in the sequence of bits encoding the second string, the symbol boundaries are. For example, if the untrusted party knows that ASCII encoding is used, the untrusted party will know that there is a symbol boundary between consecutive groups of 7 bits. If another encoding scheme, which may not produce the same number of bits for each symbol, is used, then the party performing the encryption may, for example, provide to the untrusted party, along with the sets of ciphertexts, an unencrypted list of symbol boundary locations. The results of these comparisons are ciphertexts c31, c32, . . . , c3(d2−d1+1), referred to as encrypted substring matches 115, each of which encrypts either an m-bit-vector with a leading 1 if the corresponding trial substring of the second string matches the first string, or an m-bit-vector with a leading 0 otherwise. The substring matches are combined to form a ciphertext 120 by forming the homomorphic inverse of each ciphertext, homomorphically multiplying all of the inverses together using the EvalMult operation, and then forming the homomorphic inverse of the product. The result, a ciphertext c4, is written symbolically c4=1−(1−c31)*(1−c32)* *(1−c3(d2−d1+1)), where “−” represents homomorphic modulus-2 subtraction (equivalent to homomorphic modulus-2 addition, and implemented with EvalAdd) and “*” represents homomorphic modulus-2 multiplication. The notation “1−c3i” denotes the homomorphic inverse of c3i, and may be formed by adding the homomorphic encryption of an m-bit-vector with a leading 1 to the ciphertext c3i, using EvalAdd. The homomorphic multiplication of all of the inverses, because it is performed modulus-2, is equivalent to a logical AND operation; as a result of the preceding and following inversions, c4 is the homomorphic logical OR of the c3i, by De Morgan's theorem. Decrypting the ciphertext c4 produces a vector 125, the leading bit 130 of which is 1 if the first string matches a substring of the second string, and the leading bit 130 of which is 0 if the first string does not match a substring of the second string.

The product of multiple factors (1−c31)*(1−c32)* . . . *(1−c3(d2−d1+1)) employed in the expression for c4 above may also be written EvalMult((1−c31),(1−e32), . . . , (1−c3(d2−d1+1))). This multiple-argument EvalMult operation may be implemented by operating on the factors and intermediate products pairwise using the EvalMult(a,b) operation until only one final product remains. In practice, if, at each step, intermediate products containing as nearly as possible the same number of factors are combined pairwise, the minimum degree required from an SHE scheme to implement the operation is minimized. Thus, a minimum-degree EvalMult operation may be defined recursively using the relation EvalMult(a1,a2, . . . , aj)=EvalMult(EvalMult(a1,a2, . . . , ai), EvalMult(a(i+1),a(i+2), . . . , aj)) where i=j/2 if j is even, and where i is one of the two integers nearest j/2 if j is odd.

The ciphertext c4 encrypts an m-bit-vector with a leading 1 if the first string matches at least one of the trial substrings, i.e., the first string is a substring of the second string. The reason for this is that if the first string matches at least one of the trial substrings, the corresponding ciphertext c3i will encrypt an m-bit-vector with a leading 1, its inverse will encrypt an m-bit-vector with a leading 0, the product (1−c31)*(1−c32)* . . . *(1−c3(d2−d1+1)) will encrypt an m-bit-vector with a leading 0, and the inverse, i.e., c4, will encrypt an m-bit-vector with a leading 1.

The converse is also true, i.e., ciphertext c4 encrypts an m-bit-vector with a leading 0 if the first string matches none of the trial substrings i.e., the first string is not a substring of the second string. The reason for this is that if the first string matches none of the trial substrings, the ciphertexts c31, c32, . . . c3(d2−d1+1) will each encrypt an m-bit-vector with a leading 0, each of their inverses will encrypt an m-bit-vector with a leading 1, the product (1−c31)*(1−c32)* . . . *(1−c3(d2−d1+1)) will encrypt an m-bit-vector with a leading 1, and the inverse, i.e., c4, will encrypt an m-bit-vector with a leading 0.

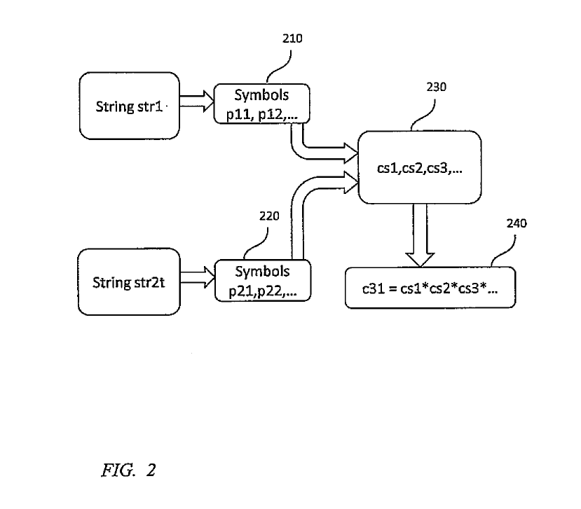

The operation of homomorphically comparing trial subsets, e.g., 101, 102, 103, 104, of the set 105 of ciphertexts corresponding to the second string, to ciphertexts 110 corresponding to the first string, to form ciphertexts e31, 32, . . . , c3(d2−d1+1) is illustrated, according to one embodiment, in FIG. 2, for the first trial substring of the second string. The first string is composed of the set of symbols 210, i.e., symbols p11, p12, . . . , p1(d1), and the trial substring, str2t, which is selected to have the same length as the first string, is composed of the set 220 of the first k1 symbols of the second string, i.e., symbols p21, p22, . . . , p2(d1). As described above, each symbol is mapped to a binary number and encoded to a set of m-bit-vectors, and each of the m-bit-vectors is encrypted using FHE or SHE, to produce two sets of ciphertexts c11, c12, . . . , c1(k1), and c21, c22, . . . , c2(k1) where each of the c1i and each of the c2i is a set of ciphertexts corresponding to one bit of one symbol. These sets of ciphertexts are then compared pairwise, the result of comparing each pair of ciphertexts being a new ciphertext. For example, if the new ciphertext cs3 is formed as cs3=EvalAdd(Enc(1,0, . . . 0),EvalAdd(c13,c23)), where EvalAdd(c13,c23) performs homomorphic addition of c13 and c23, Enc(1,0, . . . 0) is a ciphertext encrypting an m-bit-vector with a leading 1, and the expression EvalAdd(Enc(1,0, . . . 0),EvalAdd(c13,c23)) is the homomorphic inverse of the homomorphic sum of c13 and c23. The EvalAdd operation has the effect of a homomorphic logical exclusive-OR (XOR), and with the subsequent homomorphic inversion, the result, cs3, is a ciphertext encrypting an in-bit-vector with a leading 1 if the corresponding bits of the symbols p1 and p2 match, and encrypting an m-bit-vector with a leading 0 otherwise.

The pairwise homomorphic comparison of the bits in the binary representations of the symbols in the first string and in the first trial substring is performed in an analogous manner for all such bits, resulting in a set 230 of ciphertexts cs1, cs2, . . . cs(k1) where k1 is the number of bits in the binary representation of the first string.

Finally these ciphertexts are all homomorphically multiplied together to form a ciphertext 240 according to the expression c31=EvalMult(cs1, cs1, cs2, . . . cs(k1)). The ciphertext c31 then encrypts an m-bit-vector with a leading 1 if each bit in the representation of the first string matches the corresponding bit of the binary representation of the first trial substring; the ciphertext c31 encrypts an m-bit-vector with a leading 0 otherwise.

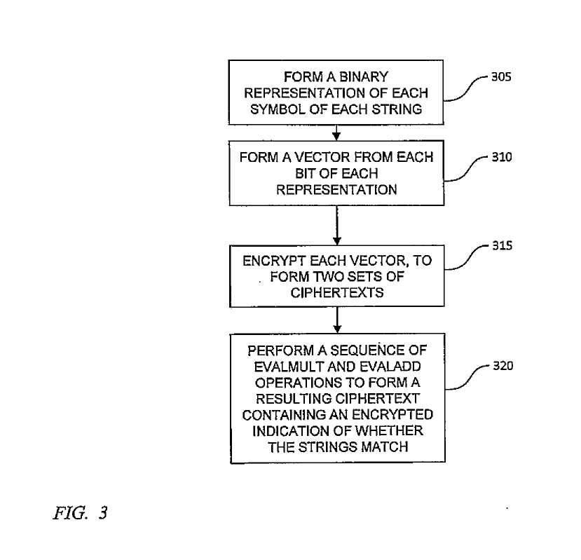

Following the embodiment of FIG. 2, FIG. 3 illustrates a method of homomorphically comparing a first string and a second string of equal length, which includes an act 305 of forming a binary representation of each of the symbols in each of the strings, forming, in an act 310, an m-bit-vector from each of the bits in the binary representations of the symbols, encrypting, in an act 315, each of the m-bit-vectors with either FHE or with a SHE scheme of sufficient degree, and performing, in an act 320, a sequence of EvalAdd and EvalMult operations resulting in a ciphertext which encrypts an m-bit-vector with a leading 1 if the strings match and which encrypts an m-bit-vector with a leading 0 if the strings do not match. In one embodiment, the operations of act 320 include homomorphically adding, using the EvalAdd operation, each bit of the binary representations of symbols in the first string to the corresponding bit of the binary representations of symbols in the second string, homomorphically forming the inverse of the result, e.g., by homomorphically adding to it a ciphertext which encrypts an m-bit-vector with a leading 1, and homomorphically forming the product, using the EvalMult operation, of all of the inverses formed in this manner.

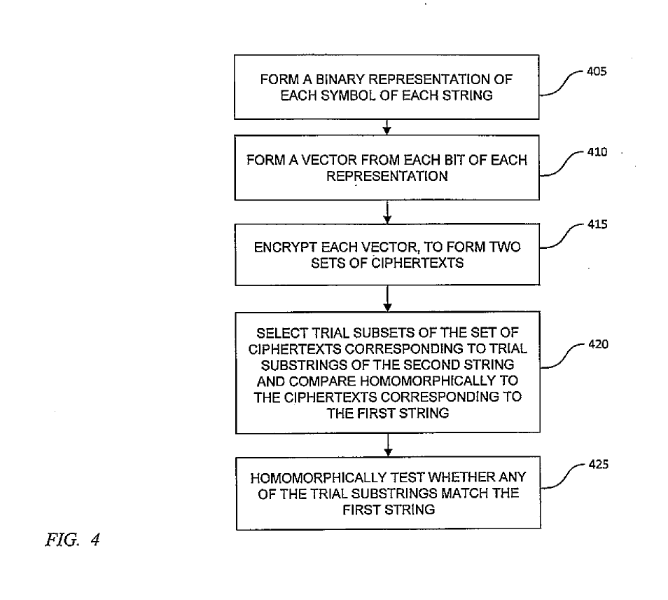

Referring to FIG. 4, in one embodiment a method for searching a second string for occurrences of a first string, based on the method illustrated in FIG. 3, includes an act 405 of forming a binary representation of each of the symbols in each of the two strings, forming, in an act 410, an m-bit-vector from each of the bits in the binary representations of the symbols, and encrypting, in an act 415, each of the m-bit-vectors with either FHE or with a SHE scheme of sufficient degree. The method then includes selecting, in an act 420, trial subsets of the set of ciphertexts corresponding to trial substrings of the second string, and comparing each trial subset homomorphically to the ciphertexts corresponding to the first string, each comparison resulting in a ciphertext c3i which encrypts an m-bit-vector with a leading 1 if the first string matches the corresponding trial substring and which encrypts an m-bit-vector with a leading 0 if the first string does not match the corresponding trial substring. Finally, the method includes, in an act 425, homomorphically testing whether any of the trial substrings match the first string. The act 425 includes homomorphically forming the inverse of each of the c3i, e.g., by homomorphically adding to it a ciphertext which encrypts an m-bit-vector with a leading 1, and homomorphically forming the product, using the EvalMult operation, of all of the inverses formed in this manner, and homomorphically inverting the product, e.g., by homomorphically adding to it a ciphertext which encrypts an m-bit-vector with a leading 1. The degree required of a SHE scheme is cei1(log 2(k1))+cei1(log 2(d2−d1+1)) where cei1 is a function that returns the smallest integer greater than its argument, log 2 denotes a base 2 logarithm, d1 is the length of the first string, in symbols, and d2 is the length of the second string, in symbols. Whether the string being searched for, i.e., the first string, is in the string being searched over, i.e., the second string, may then be determined by decrypting the final ciphertext, to obtain an m-bit-vector, and testing its first bit. If the first bit is a 1, then the first string is part of the second string; if the first bit is 0, then the first string is not part of the second string.

Operations performed in embodiments of the present invention, such as the acts listed in FIGS. 3 and 4, may be performed with a processing unit. The term “processing unit” is used herein to include any combination of hardware, firmware, and software, employed to process data or digital signals. Processing unit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs).

Although limited embodiments of a method for secure substring search have been specifically described and illustrated herein, many modifications and variations will be apparent to those skilled in the art. For example, the mapping used to form a binary representation of the symbols in the string being searched for and in the string being search over need not be ASCII but may be any suitable mapping for the alphabet from which the symbols are selected. Accordingly, it is to be understood that the method for secure substring search employed according to principles of this invention may be embodied other than as specifically described herein. The invention is also defined in the following claims, and equivalents thereof.

What is claimed is:

1. A method for determining whether a first string is a substring of a second string, the method comprising:
performing a first sequence of operations, on:
a set of first ciphertexts corresponding to the first string; and
a set of second ciphertexts corresponding to a trial substring of the second string,
to form a resulting third ciphertext containing an encrypted indication of whether the first string matches the trial substring.

2. The method of claim 1, wherein the first sequence of operations comprises one or more EvalAdd operations and one or more EvalMult operations.

3. The method of claim 1, comprising:
performing the first sequence of operations one or more times for a plurality of trial substrings to form a plurality of resulting third ciphertexts, each time selecting as the trial substring a different substring of the second string, the substring of the second string having the same length as the first string; and
performing a second sequence of operations on the plurality of resulting third ciphertexts; to form a fourth ciphertext.

4. The method of claim 3, wherein each of the plurality of resulting third ciphertexts contains an encrypted indication of whether the first string matches a corresponding trial substring of the second string.

5. The method of claim 3, wherein the fourth ciphertext contains an encrypted indication of whether the first string is a substring of the second string.

6. The method of claim 3, wherein each of the first string and the trial substring of the second string comprise symbols, the method further comprising:
converting each symbol into a binary representation of the symbol;
encoding each binary representation to form a first set of plaintext vectors; and
encrypting each plaintext vector with a homomorphic encryption scheme to form a ciphertext.

7. The method of claim 6, wherein the first sequence of operations comprises:
performing an EvalAdd operation with:
a ciphertext corresponding to a bit of a binary representation of a symbol of the first string; and
a ciphertext corresponding to a corresponding bit of a binary representation of a corresponding symbol of the trial substring;
to obtain a first intermediate ciphertext;
performing an EvalAdd operation with:
the first intermediate ciphertext; and
a ciphertext encrypting a vector of bits with a leading 1;
to obtain a second intermediate result.

8. The method of claim 7, comprising performing an EvalMult operation on a plurality of second intermediate results to obtain a resulting third ciphertext.

9. The method of claim 8, comprising:
homomorphically inverting each of a plurality of resulting third ciphertexts to obtain a first plurality of inverses;
performing an EvalAdd operation with the first plurality of inverses to obtain a first intermediate product; and
homomorphically inverting the first intermediate product to form the fourth ciphertext,
wherein the homomorphically inverting comprises performing an EvalAdd operation with:
a quantity being homomorphically inverted; and
a ciphertext encrypting a vector of bits with a leading 1.

10. The method of claim 6, wherein the encrypting of each plaintext vector with a homomorphic encryption scheme comprises encrypting each plaintext vector with a fully homomorphic encryption scheme.

11. A system for determining whether a first string is a substring of a second string, the system comprising a processing unit configured to
perform a first sequence of operations, on:
a set of first ciphertexts corresponding to the first string; and
a set of second ciphertexts corresponding to a trial substring of the second string,
to form a resulting third ciphertext containing an encrypted indication of whether the first string matches the trial substring.

12. The system of claim 11, wherein the first sequence of operations comprises one or more EvalAdd operations and one or more EvalMult operations.

13. The system of claim 11, wherein the processing unit is configured to:
perform the first sequence of operations one or more times for a plurality of trial substrings to form a plurality of resulting third ciphertexts, each time selecting as the trial substring a different substring of the second string, the substring of the second string having the same length as the first string; and
perform a second sequence of operations on the plurality of resulting third ciphertexts; to form a fourth ciphertext.

14. The system of claim 13, wherein each of the plurality of resulting third ciphertexts contains an encrypted indication of whether the first string matches a corresponding trial substring of the second string.

15. The system of claim 13, wherein the fourth ciphertext contains an encrypted indication of whether the first string is a substring of the second string.

16. The system of claim 13, wherein each of the first string and the trial substring of the second string comprise symbols, the processing unit further configured to:
convert each symbol into a binary representation of the symbol;
encode each binary representation to form a first set of plaintext vectors; and
encrypt each plaintext vector with a homomorphic encryption scheme to form a ciphertext.

17. The system of claim 16, wherein the first sequence of operations comprises:
performing an EvalAdd operation with:
a ciphertext corresponding to a bit of a binary representation of a symbol of the first string; and
a ciphertext corresponding to a corresponding bit of a binary representation of a corresponding symbol of the trial substring;
to obtain a first intermediate ciphertext;
performing an EvalAdd operation with:
the first intermediate ciphertext; and
a ciphertext encrypting a vector of bits with a leading 1;
to obtain a second intermediate result.

18. The system of claim 17, wherein the processing unit is further configured to perform an EvalMult operation on a plurality of second intermediate results to obtain a resulting third ciphertext.

19. The system of claim 18, wherein the processing unit is further configured to:
homomorphically invert each of a plurality of resulting third ciphertexts to obtain a first plurality of inverses;
perform an EvalAdd operation with the first plurality of inverses to obtain a first intermediate product; and
homomorphically invert the first intermediate product to form the fourth ciphertext,
wherein the homomorphically inverting comprises performing an EvalAdd operation with:
a quantity being homomorphically inverted; and
a ciphertext encrypting a vector of bits with a leading 1.

20. The system of claim 16, wherein the encrypting of each plaintext vector with a homomorphic encryption scheme comprises encrypting each plaintext vector with a fully homomorphic encryption scheme.
